(19) United States
(12) Patent Application Publication
(10) Pub. No.: US 2025/0080500 A1
(43) Pub. Date: Mar. 6, 2025

(54) SYSTEM AND METHOD FOR SECURITY INSPECTION OF IP TRAFFIC IN A CORE NETWORK

(71) Applicant: Rohde & Schwarz GmbH & Co. KG, Munich (DE)

(72) Inventor: Stefan URBAN, Wurzen (DE)

(21) Appl. No.: 18/240,898

(22) Filed: Aug. 31, 2023

(51) Int. Cl. H04L 9/40

(52) U.S. Cl. CPC H04L 63/0281; H04L 63/1416; H04L 63/145

(57) ABSTRACT

The present disclosure relates to a system and a method for security inspection of IP traffic in a core network. The system comprises at least one service communication proxy which comprises at least one interface and a processor; wherein the interface is configured to receive the IP traffic; wherein the processor is configured to decrypt at least one layer of communication of the received IP traffic; and wherein the processor is further configured to perform a security inspection on the at least one decrypted layer.

### TECHNICAL FIELD

The present disclosure relates to a system and a method for security inspection of IP traffic in a core network, such as a 5G or 6G mobile core network.

### BACKGROUND ART

In general, a mobile network comprises a core network and a radio access network (RAN). The core network transfers the network traffic and provides many of the key network functions, while the RAN provides a connection between a user equipment, e.g. a mobile device, and the network.

To detect unwanted entities in the core network, such as intruders or malware, a so-called deep packet inspection (DPI) analysis can be carried out. Deep packet inspection is a method in network technology to process and inspect data that is sent over the network. For example, during deep packet inspection, data from several layers, e.g. layers 3 to 7, of an OSI layer stack are examined on a per-packet basis. However, often an encryption of the communication data in the network makes it difficult to detect intruders or other unwanted entities with a conventional DPI analysis, because the intruders can “hide” behind the encryption.

### SUMMARY

Thus, there is a need to provide an improved system and an improved method for security inspection of IP traffic in a core network.

These and other objectives are achieved by the embodiments provided in the enclosed independent claims. Advantageous implementations of the embodiments of the present disclosure are further defined in the dependent claims.

According to a first aspect, the present disclosure relates to a system for security inspection of internet protocol (IP) traffic in a core network. The system comprises at least one service communication proxy which comprises at least one interface and a processor; wherein the at least one interface is configured to receive the IP traffic; wherein the processor is configured to decrypt at least one layer of communication of the received IP traffic; and wherein the processor is further configured to perform a security inspection on the at least one decrypted layer.

This achieves the advantage the security in the core network can be enhanced. By performing the security inspection on decrypted data, intruders in the core network can be detected and isolated more efficiently, because they can no longer “hide” behind the encryption.

The core network can be a mobile core network, for instance a 5G or 6G core network. The system can be comprised in the core network and can form a part or component of the core network.

The core network can be configured to employ strict network policies that forbid direct communication between different network functions. In this case, for instance, all communications between two network functions in the core network goes through one of the service communication proxies that can perform said security inspection on the communication.

The service communication proxy can be implemented in the core network in the form of a service communication proxy module or unit. The service communication proxy can be a virtual network module and/or can at least partially be implemented via hardware.

The network functions may refer to network function entities or network function modules. These network function entities or modules can be implemented in the core network via software, via hardware or via a software/hardware combination. For example, at least one of the network functions can be formed as a virtual entity by executing a dedicated software or software package. Examples of such network functions are: a session management function, an authentication server function, or an access and mobility management function which establishes a connected to a 5G or 6G RAN.

The at least one interface is configured to receive and/or transmit control plane traffic.

In an implementation form of the first aspect, the processor is configured to perform a policy action on at least a part of the IP traffic based on the results of the security inspection.

In an implementation form of the first aspect, the security inspection comprises an intrusion detection, an intrusion prevention, a virus detection, a malware detection and/or an anomaly detection of protocols and/or communication. This achieves the advantage that different types of unwanted entities can be detected and removed efficiently.

In an implementation form of the first aspect, the processor is configured to use an artificial intelligence, AI, algorithm to carry out the security inspection.

For example, the processor uses artificial intelligence intrusion detection.

In an implementation form of the first aspect, the decrypted layer is any one of the following OSI layers: a data link layer, a network layer, a transport layer, or an application layer.

In an implementation form of the first aspect, the processor is configured to re-encrypt the decrypted IP traffic after the security inspection. Thereby, for instance, the at least one layer which was previously decrypted is re-encrypted.

In an implementation form of the first aspect, the at least one interface is configured to transmit the IP traffic after said re-encryption. Thus, the service communication proxy can relay traffic between two entities, e.g. two network functions, of the core network and thereby perform a security inspection on the traffic.

In an implementation form of the first aspect, the processor is configured not to encrypt the decrypted IP traffic after the security inspection if the core network does not use encryption internally.

In an implementation form of the first aspect, the at least one interface is configured to transmit the unencrypted IP traffic after performing the security inspection.

In an implementation form of the first aspect, the system comprises a plurality of the service communication proxies; wherein the plurality of the service communication proxies are configured to share a communication load between two resources in the core network among themselves.

For example, the core network can be configured to perform a flow/endpoint stable load balancing between the multiple service communication proxies.

In an implementation form of the first aspect, the plurality of the service communication proxies are configured to exchange information on their respective loads.

In an implementation form of the first aspect, the service communication proxy is configured to mediate a communication between different network functions in the core network.

For instance, the core network is configured to employ network policies that forbid direct traffic between network functions. Thus, all traffic between network functions can be relayed via and inspected by a service communication proxy. E.g., the system comprises a policy control function or module which is configured to provide and/or implement this network policy.

According to a second aspect, the present disclosure relates to a method for security inspection of IP traffic in a core network, comprising the steps of: receiving the IP traffic at a service communication proxy; decrypting at least one layer of communications of the received IP traffic; and performing a security inspection on the at least one decrypted layer.

In an implementation form of the second aspect, the method comprises the further step of: performing a policy action on at least a part of the IP traffic based on the results of the security inspection.

In an implementation form of the second aspect, the security inspection comprises an intrusion detection, an intrusion prevention, a virus detection, a malware detection and/or an anomaly detection of protocols and/or communication.

In an implementation form of the second aspect, the method comprises the further step of: re-encrypting the decrypted IP traffic after the security inspection.

In an implementation form of the second aspect, the method comprises the further step of: transmitting the IP traffic after said re-encryption.

### BRIEF DESCRIPTION OF THE DRAWINGS

The above described aspects and implementation forms of the present disclosure will be explained in the following description of specific embodiments in relation to the enclosed drawings, in which:

FIG. 1 shows a schematic diagram of a system for security inspection of IP traffic in a core network according to an embodiment;

FIG. 2 shows a schematic diagram of a system for security inspection of IP traffic in a core network according to an embodiment; and

FIG. 3 shows a flow diagram of a method for security inspection of IP traffic in a core network according to an embodiment.

### DETAILED DESCRIPTIONS OF EMBODIMENTS

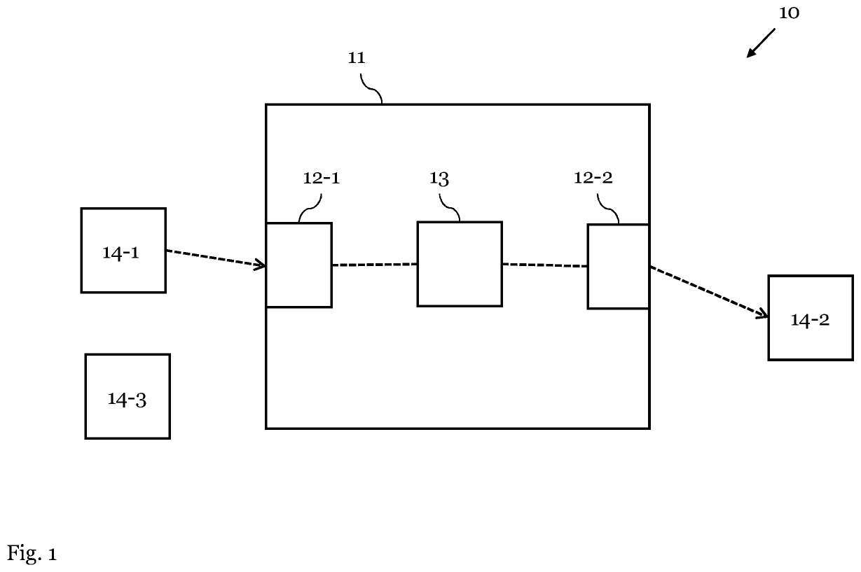

FIG. 1 shows a schematic diagram of a system 10 for security inspection of IP traffic in a core network according to an embodiment.

The system 10 comprises at least one service communication proxy (SCP) 11 which comprises at least one interface 12-1, 12-2 and a processor 13. The interface 12-1, 12-2 is configured to receive the IP traffic; the processor 13 is configured to decrypt at least one layer of communication of the received IP traffic; wherein the processor 13 is further configured to perform a security inspection on the at least one decrypted layer.

The core network can be a mobile core network, e.g. for 5G or 6G communication. The SCP can also be a session communication proxy in the core network.

The at least one interface 12-1, 12-2 can be configured to receive and transmit IP traffic. For instance, the at least one interface 12-1, 12-2 comprises a first interface 12-1 configured to receive the IP traffic and a second interface 12-2 configured to forward at least a part of the IP traffic after the security inspection.

The IP traffic that is received and/or transmitted by the at least one interface 12-1, 12-2 can be control plane traffic.

The SCP 11 can be configured to mediate a communication between different network functions 14-1, 14-2 in the core network.

For instance, the core network is configured to employ network policies that forbid direct traffic between network functions 14-1, 14-2. Therefore, the system 10 can comprise a policy control function 14-3 or module which is configured to provide and/or implement this network policy.

For instance, due to the network policy in the core network, the network functions 14-1, 14-2 will decline any request/connection from non-SCP 11 network functions. This guarantees that all traffic between network functions is “routed” via the at least one SCP 11.

The processor 13 can be configured to carry out an “encryption inspection” by terminating the communication encryption of the at least one communication layer and inspecting the cleartext communication. By decrypting the layer and performing the security inspection on the decrypted layer, a detection of intruders and other unwanted entities and actions in the core network can be improved.

This “encryption inspection” can be performed on any OSI layer, such as a data link layer, a network layer, a transport layer, and/or an application layer. The processor 13 can thereby use any suitable kind of encryption protocol, such as L2TP, IPSec, TLS or a proprietary protocol.

The security inspection (or security analysis) that is performed by the processor 13 on the decrypted (cleartext) communication can comprise any one of the following: an intrusion detection, an intrusion prevention, a virus detection, a malware detection or an anomaly detection of protocols/communication.

The processor 13 can use artificial intelligence (AI), e.g. machine learning (ML) algorithms, to carry out the security inspection. For instance, the processor can comprise a neural network that carries out at least a part of the security inspection.

The processor 13 can use the results of this security inspection to determine the next steps. For instance, the next step is a policy action on at least a part of the IP traffic, e.g. a part for which a security risk (e.g., an intrusion, virus or malware risk) was detected.

The policy action may comprise: dropping or discarding packets of the IP traffic, e.g. packets for which an security risk was detected, and/or finding and isolating a detected intruder or user. For instance, the policy action can prevent that parts of an IP traffic for which a security risk was detected is not passed over to a network function. However, the policy action may also comprise a normal processing of the IP traffic (e.g., re-encryption and forwarding) if no security risk was detected.

After performing the security inspection on passing IP traffic, the processor 13 can be configured to encrypt (i.e., re-encrypt) the decrypted cleartext IP traffic for forwarding. Thereby, for instance, the at least one layer, which was previously decrypted, is re-encrypted. The at least one interface 12-2, e.g. the second interface 12-2, can be configured to subsequently transmit the re-encrypted IP traffic to a target in the network, e.g. to a further network function 14-2.

In case the core network does not use encryption internally, the last part of re-encrypt the communication can be dropped, i.e., the processor 13 can be configured to re-encrypt the decrypted (cleartext) IP traffic. In this case, the at least one interface 12-1, 12-2, e.g. the second interface 12-1, can be configured to transmit the unencrypted IP traffic after performing the security inspection. However, in a mobile core network, a re-encryption would typically be carried out.

Furthermore, in case the traffic is internally communicated unencrypted (and the re-encryption can be dropped), the SCP 11 may function as a gateway for incoming traffic, e.g. incoming external communications. This can be referred to as an “ingress”, because the gateway usually controls both directions (in and out of the system).

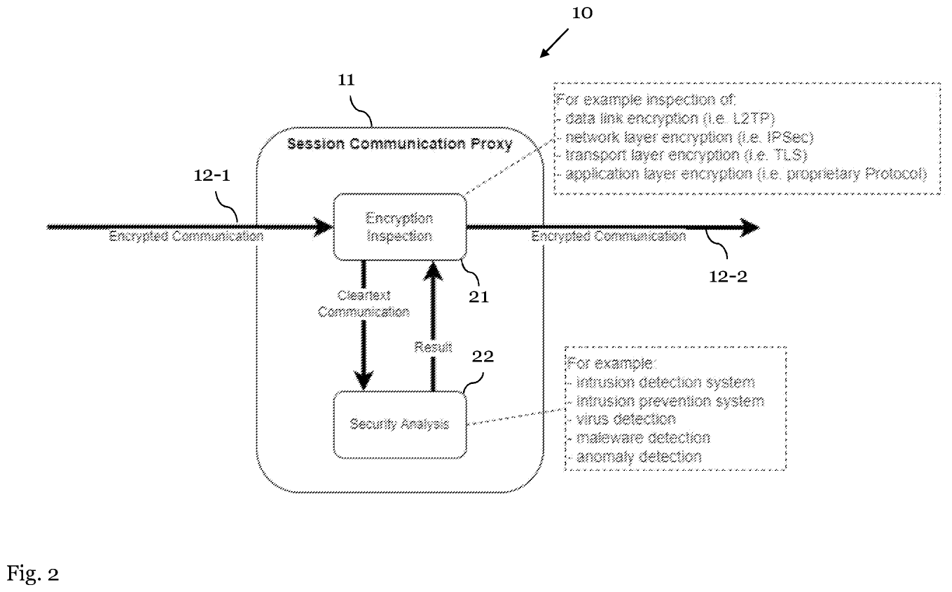

FIG. 2 shows a schematic diagram of the system 10 for security inspection of IP traffic in the core network according to an embodiment.

The SCP 11 in FIG. 2 comprises an encryption inspection module 21 and a security analysis module 22. Both the encryption inspection module 21 and the security analysis module 22 can be implemented and/or executed by the processor 13 of the SCP 11.

For example, the encryption inspection module 21 can carry out the encryption inspection of traffic which is encrypted according to any one of the following encryption protocols: data link encryption (i.e., L2TP), network layer encryption (i.e., IPSec), transport layer encryption (i.e., TLS), application layer encryption (i.e., proprietary protocol). The encryption inspection module 21 can be configured to decrypt the encrypted IP traffic, which is received via a first interface 12-1 of the SCP 11, to generate a cleartext communication.

The security analysis module 22 can receive the cleartext communication from the encryption inspection module 21 and carry out a security analysis on the cleartext communication. The security analysis can comprise: an intrusion detection, an intrusion prevention, a virus detection, a malware detection or an anomaly detection. For instance, the security analysis module 22 can comprise an intrusion detection system and/or an intrusion prevention system.

Based on the results of the security analysis, the security analysis module 22 can inform the encryption inspection module 21 to carry out the policy action on the received encrypted communication, e.g. drop certain data packets or re-encrypt data-packets and forward them via the second interface 12-2.

The system 10 as shown in FIG. 1 or 2 can comprise a plurality of SCPs 11. These SCPs 11 can share a communication load, e.g. between two network functions 14-1, 14-2 in the core network. In many core networks, there is a large amount of traffic that needs to be handled.

For instance, in a scaled core network, a flow or endpoint stable load balancing can be carried out to share the load between the SCPs 11.

The plurality of the service communication proxies 11 can also be configured to communicate with each other, e.g., exchange information on their respective loads. In this case, the flow or endpoint stable load balancing by the core network might not be necessary.

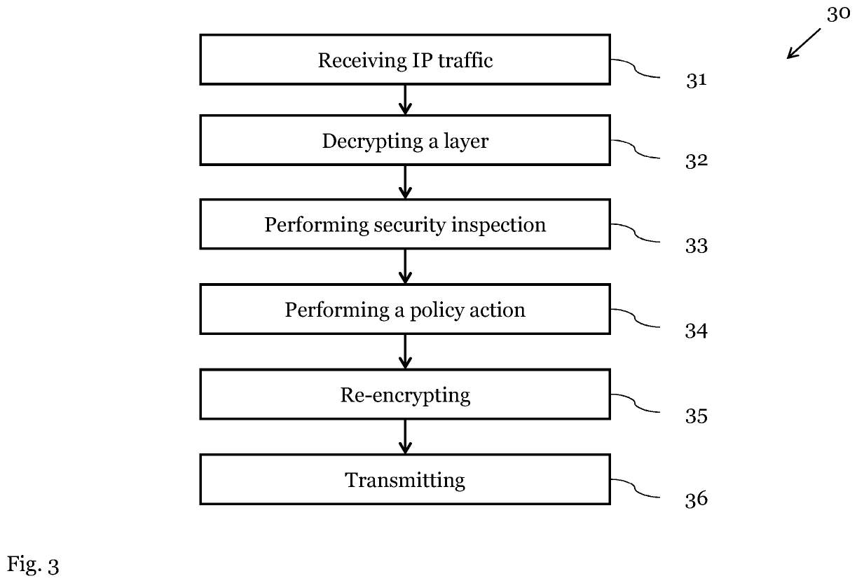

FIG. 3 shows a flow diagram of a method 30 for security inspection of IP traffic in the core network according to an embodiment.

The method 30 comprises the steps of: receiving 31 the IP traffic at the service communication proxy 11; decrypting 32 at least one layer of communications of the received IP traffic; and performing 33 the security inspection on the at least one decrypted layer.

The method can comprise the further step of: performing 34 the policy action on at least a part of the IP traffic based on the results of the security inspection.

The security inspection can comprises an intrusion detection, an intrusion prevention, a virus detection, a malware detection and/or an anomaly detection of protocols and/or communication.

The method 30 can comprise the further steps of: re-encrypting 35 the decrypted IP traffic after the security inspection, and transmitting 36 the IP traffic after said re-encryption.

The method 30 may further comprise: employing network policies in the core network that forbid direct traffic between network functions in the core network. In this way, it can be ensured that all traffic in the core network goes through one of the service communication proxies

The method 30 can be carried out by the system 10 as shown in any one of FIGS. 1 and 2.

All features described above or features shown in the figures can be combined with each other in any advantageous manner within the scope of the disclosure.

1. A system for security inspection of IP traffic in a core network, comprising
at least one service communication proxy which comprises at least one interface and a processor;
wherein the interface is configured to receive the IP traffic;
wherein the processor is configured to decrypt at least one layer of communication of the received IP traffic; and
wherein the processor is further configured to perform a security inspection on the at least one decrypted layer.

2. The system of claim 1,
wherein the processor is configured to perform a policy action on at least a part of the IP traffic based on the results of the security inspection.

3. The system of claim 1,
wherein the security inspection comprises an intrusion detection, an intrusion prevention, a virus detection, a malware detection and/or an anomaly detection of protocols and/or communication.

4. The system of claim 1,
wherein the processor is configured to use an artificial intelligence, AI, algorithm to carry out the security inspection.

5. The system of claim 1,
wherein the decrypted layer is any one of the following OSI layers: a data link layer, a network layer, a transport layer, or an application layer.

6. The system of claim 1,
wherein the processor is configured to re-encrypt the decrypted IP traffic after the security inspection.

7. The system of claim 6,
wherein the at least one interface is configured to transmit the IP traffic after said re-encryption.

8. The system of claim 1,
wherein the processor is configured not to encrypt the decrypted IP traffic after the security inspection if the core network does not use encryption internally.

9. The system of claim 8,
wherein the at least one interface is configured to transmit the unencrypted IP traffic after performing the security inspection.

10. The system of claim 1,
wherein the system comprises a plurality of the service communication proxies;
wherein the plurality of the service communication proxies are configured to share a communication load between two resources in the core network among themselves.

11. The system of claim 10,
wherein the plurality of the service communication proxies are configured to exchange information on their respective loads.

12. The system of claim 1,
wherein the service communication proxy is configured to mediate a communication between different network functions in the core network.

13. A method for security inspection of IP traffic in a core network, comprising the steps of:
receiving the IP traffic at a service communication proxy;
decrypting at least one layer of communications of the received IP traffic; and
performing a security inspection on the at least one decrypted layer.

14. The method of claim 13, further comprising the step of:
performing a policy action on at least a part of the IP traffic based on the results of the security inspection.

15. The method of claim 13,
wherein the security inspection comprises an intrusion detection, an intrusion prevention, a virus detection, a malware detection and/or an anomaly detection of protocols and/or communication.

16. The method of claim 13, further comprising the step of:
re-encrypting the decrypted IP traffic after the security inspection.

17. The method of claim 16, further comprising the step of:
transmitting the IP traffic after said re-encryption.
